(19) United States
(12) Patent Application Publication
(10) Pub. No.: US 2020/0182601 A1
(43) Pub. Date: Jun. 11, 2020

(54) METHOD FOR CONTROLLING THE CONFORMITY OF THE PROFILE OF A CURVED SURFACE OF A TURBOMACHINE ELEMENT

(71) Applicant: SAFRAN AIRCRAFT ENGINES, Paris (FR)

(72) Inventors: Dominique Maurice Gerard BEIGNON, Moissy-Cramayel (FR); Antoine BERSON, Moissy-Cramayel (FR)

(21) Appl. No.: 16/331,479

(22) PCT Filed: Sep. 8, 2017
(86) PCT No.: PCT/FR2017/052386

§ 371 Date: Mar. 7, 2019

(30) Foreign Application Priority Data
Sep. 9, 2016 (FR) 1658343

(51) Int. Cl. G01B 5/20; G01B 11/00; G01B 11/24; G01B 5/008

(52) U.S. Cl. CPC G01B 5/205; G01B 5/008; G01B 11/24; G01B 11/002

(57) ABSTRACT

The invention relates to a method for controlling the conformity of a profile of a section of a curved surface of a turbomachine element, comprising the following step: —(100) acquiring coordinates of a plurality of measurement points of the section in a frame of reference defined for said section; characterised in that the method comprises the following steps: —(200) calculating, based on the coordinates of these measurement points, the radius of curvature of the section at each of these points, in order to obtain a measured evolution curve of the radius of curvature according to the position of the measurement points along said section; —(300) comparing the measured evolution curve of the radius of curvature, obtained in the preceding step, with a theoretical evolution curve of the radius of curvature of the predetermined section; —(400) evaluating the conformity of the section based on the comparison carried out in the preceding step.

### GENERAL TECHNICAL FIELD

The present invention relates to a control method of the conformity of the profile of a section of a curved surface of an element of a turbomachine, for example of a section of a blade of a turbomachine for an aircraft, to verify that the section of the curved surface of said element complies with the manufacturing criteria set during the designing of said element.

The present invention can therefore relate especially to a control method of the conformity of the radiated profile of a leading edge and/or of a trailing edge of the blade to verify that the form of the leading edge and/or of the trailing edge of the blade properly complies with the manufacturing criteria set during the designing of the blade.

### PRIOR ART

During manufacture of a curved surface of an element of a turbomachine, it is known to carry out control of the conformity of the profile of a section of the curved surface to verify if the element complies with the manufacturing criteria set during the designing of said element.

Accordingly, during the manufacture of a blade of a turbomachine for an aircraft, for example a blade of a fan or of a compressor blade, a control step of the conformity of this blade is conducted to verify whether the form of said blade complies with the manufacturing criteria which have been set during the designing of said blade.

The leading edge and the trailing edge of the blade, and particularly the leading edge, are zones of the blade whereof the form has a major impact on the aerodynamic performance of said blade. In this way, it is important for the leading edge and the trailing edge of the blade to have a form complying with the form defined during the designing of said blade so that said blade has the preferred aerodynamic characteristics.

According to a known method illustrated in FIG. 1, control of the conformity of a blade 1 is executed by comparing the blade 1 to a maximum blade profile 11 and a minimum blade profile 12. The maximum profile 11 corresponds to the maximum thickness authorised for the blade 1, and the minimum profile 12 corresponds to the minimum thickness authorised for said blade 1. The maximum profile 11 and the minimum profile 12 are set by applying a tolerance threshold to the optimal thickness of the blade set during the designing of the blade 1.

But the method illustrated in FIG. 1 controls only whether the thickness of the blade 1 is contained within the tolerance threshold defined by the maximum profile 11 and the minimum profile 12, and does not detect whether the leading edge or the trailing edge has an unacceptable radiated form, such as for example those shown in FIG. 2. For example, the leading edge, or the trailing edge of the blade 1, can have an unacceptable form if it is too pointed while being within the acceptable tolerance threshold.

To control the profile of the leading edge and the profile of the trailing edge of the blade 1, a visual check by the operators of quality control must therefore be made to compare the profile of the leading edge and of the trailing edge to profiles of unacceptable forms such as illustrated in FIGS. 2b to 2h, with FIG. 2a as such illustrating the preferred profile.

FIG. 2b illustrates a lateral offset of the end of the leading edge or of the trailing edge. FIG. 2c illustrates a leading edge or a trailing edge whereof the profile is too rounded. FIG. 2d illustrates a leading edge or a trailing edge comprising notches. FIG. 2e illustrates a leading edge or a trailing edge comprising a flat spot. FIG. 2f illustrates a leading edge or an overly pointed trailing edge since it comprises two flat spots forming a point. FIG. 2g illustrates a leading edge or a trailing edge comprising a slight flat spot combined with slight lateral offset. Finally FIG. 2h illustrates an excessively thin leading edge or trailing edge.

However, this control method proves inadequate for correctly appreciating the conformity of the blades and especially poses problems in terms of repeatability and reproducibility.

Document WO2012/152255 is known (which also corresponds to document US2014/0076038) which describes a method for controlling the profile of a section of a blade. Control of the profile is done by seeing whether the measured profile of the section of the blade is contained within an acceptable tolerance interval. The method can also comprise comparison of the minimal radius of curvature of the section to a minimal theoretical radius of curvature. But such a method fails to detect and reveal all defects which can be presented by a section of an element of a turbomachine, especially a blade. Also, analysis of the minimal radius of curvature is focused on the leading edge or the trailing edge of the blade.

### GENERAL PRESENTATION OF THE INVENTION

A general aim of the invention is to propose a control method of the profile of a section of a curved surface which has none of the drawbacks of the prior art.

Another aim of the invention is to propose a control method which is reliable, independent of measuring means and which allows quantitative, objective and complete appreciation of the conformity of the curved surface, and especially of the radius of curvature of the leading edge and/or of the trailing edge of a blade.

More particularly, according to a first aspect the invention relates to a control method of the conformity of a profile of a section of a curved surface of an element of a turbomachine comprising the following step:
acquiring coordinates of several measurement points of the section in a frame of reference defined for said section;

characterized in that the method comprises the following steps:
calculating from the coordinates of these measurement points the radius of curvature of the section at each of these points so as to obtain a measured curve of evolution of the radius of curvature according to the position of the measurement points along said section;
comparing the measured curve of evolution of the radius of curvature obtained at the preceding step to a theoretical curve of evolution of the radius of curvature of the section which is predetermined, with the following steps:
identifying at least one singular point in the measured curve of evolution of the radius of curvature corresponding to a local extremum of said measured curve of evolution;
counting the number of identified singular points;
measuring parameters of conformity by comparing the singular points to particular points of the theoretical curve of evolution of the radius of curvature, the measured parameters and the particular points of the theoretical curve of evolution depending on the number of singular points counted at the preceding step;
evaluating the conformity of the section of the curved surface from the comparison performed at the preceding step by evaluation of the conformity of the section of the curved surface by comparing the parameters to predetermined values.

Such a method on the one hand easily detects the defects in the profile of the section, and especially in the profile of the leading edge and/or of the trailing edge of the blade, the defects appearing more clearly by comparing the measured curve of evolution of the radius of curvature to the theoretical curve of evolution.

The method according to the invention is advantageously completed by the following characteristics, taken singly or in any of their technically possible combinations:
the calculation of the radius of curvature at a measurement point is performed by measuring the radius of a circle passing through said measurement point and the two measurement points which follow said measurement point along the section;
the step for identifying at least one singular point comprises the following step:
   discriminating the local identified extrema by taking as singular point only one extremum whereof the variation in value of the radius of curvature relative to the adjacent extrema is greater than a predetermined threshold;
the method comprises the following steps:
   measuring, when a single singular point is counted, the difference in radius of curvature on the one hand between the singular point and on the other hand a particular point corresponding to the minimum of the radius of curvature of the theoretical curve of evolution of the radius of curvature;
   evaluating the conformity of the section by comparing the difference in radius of curvature measured at the preceding step to a predetermined tolerance threshold;
the method comprises the following step:
   setting the section as non-compliant, when only two singular points are counted;
the method comprises the following steps:
   measuring, when only three singular points are counted, the difference in radius of curvature on the one hand between a singular point among said three singular points having the maximum radius of curvature, and on the other hand a particular point corresponding to the point of the theoretical curve of evolution having the same position along the section as the singular point having the maximum radius of curvature;
   comparing this difference in radius of curvature to a predetermined threshold value;
   measuring, if the difference in radius of curvature is less than the threshold value, the following parameters:
   the distance along the section on the one hand between a singular point among the three singular points having the minimum radius of curvature, and on the other hand a particular point having the minimum radius of curvature of the theoretical curve of evolution;
   the sign of the difference in radius of curvature on the one hand between the singular point having the minimum radius of curvature, and on the other hand the particular point having the minimum radius of curvature;
   the difference in radius of curvature on the one hand between the singular point having the minimum radius of curvature, and on the other hand a particular point corresponding to the point of the theoretical curve of evolution having the same position along the section as the singular point having the minimum radius of curvature;
   evaluating the conformity of the section by comparing the distance, the difference in radius of curvature, and the sign of the difference in radius of curvature measured at the preceding step to predetermined tolerance thresholds.
   measuring, if the difference in radius of curvature is greater than the threshold value, the distance along the section between the two singular points other than the singular point having the maximum radius of curvature;
   evaluating the conformity of the section by comparing the distance measured at the preceding step, as well as the difference in radius of curvature on the one hand between the singular point having the maximum radius of curvature and on the other hand the particular point of the theoretical curve of evolution having the same position along the surface, to predetermined tolerance thresholds;
the method comprises the following steps:
   detecting inversion of curvature by determining a centre of a circle passing through three measurement points and whether said centre of the circle is located outside the section;
   setting the section of the blade as non-compliant if the centre of the circle is located outside the section.

According to another aspect, the invention also relates to a control method of the conformity of a profile of a leading edge and/or of a trailing edge of a blade of a turbomachine comprising the following step:
executing the control method of the conformity of the profile of a section of a curved surface of an element according to the first aspect, wherein the element is the blade and said curved surface comprises the leading edge and/or the trailing edge of said blade, said control method being executed on a plurality of sections of said blade distributed along said blade.

### DESCRIPTION OF FIGURES

Other characteristics, aims and advantages of the present invention will emerge from the following detailed description and with respect to the appended drawings given by way of non-limiting examples and in which:

FIG. 1 illustrates a control method of the profile of a section of a blade according to the prior art;

FIG. 2a illustrates the preferred profile for the trailing edge and the leading edge of a blade;

FIGS. 2b-2h illustrate profiles of unacceptable forms for the trailing edge and the leading edge of a blade compared to the profile of FIG. 2a;

FIG. 3 illustrates the main steps of a control method of the conformity of a profile of a section of the leading edge and/or of the trailing edge of a blade;

FIG. 4 illustrates a possible acquisition method of the coordinates of measurement points;

FIG. 5 illustrates a possible method for calculation of the radius of curvature of the controlled zone in each of the measurement points;

FIG. 6 illustrates a measured curve of evolution of the radius of curvature of the blade in the controlled zone;

FIG. 7a illustrates superposition of the measured profile of the controlled zone of a blade which presents a defect with a theoretical profile of said zone of the blade such as designed;

FIG. 7b illustrates superposition of the measured curve of evolution of the radius of curvature of the zone corresponding to the measured profile of FIG. 7a, with a theoretical curve of evolution of the radius of curvature of the theoretical profile of FIG. 7a;

FIG. 8a illustrates superposition of the measured profile of the controlled zone of a blade which presents a defect with the theoretical profile of said zone of the blade such as designed;

FIG. 8b illustrates superposition of the measured curve of evolution of the radius of curvature of the zone corresponding to the measured profile of FIG. 8a, with a theoretical curve of evolution of the radius of curvature of the theoretical profile of FIG. 8a;

FIG. 9a illustrates superposition of the measured profile of the controlled zone of a blade which presents a defect with the theoretical profile of the zone of the blade such as designed;

FIG. 9b illustrates superposition of the measured curve of evolution of the radius of curvature of the zone corresponding to the measured profile of FIG. 9a, with a theoretical curve of evolution of the radius of curvature of the theoretical profile of FIG. 9a;

FIG. 10 illustrates a possible variant of the steps of comparison and evaluation of the control method of the profile of a section of a blade;

FIG. 11a illustrates superposition of the measured profile of the controlled zone of a blade which presents a defect with a theoretical profile of said zone of the blade such as designed;

FIG. 11b illustrates superposition of the measured curve of evolution of the radius of curvature of the zone corresponding to the measured profile of FIG. 11a, with a theoretical curve of evolution of the radius of curvature of the theoretical profile of FIG. 11a, the singular points of the measured curve of evolution being identified;

FIG. 12 illustrates a possible variant of the step for identifying at least one singular point of the measured curve of evolution of the radius of curvature;

FIG. 13 illustrates a possible variant of the measuring step of parameters of conformity and of the evaluation step of the conformity of the section of the blade;

FIG. 14a illustrates superposition of the measured profile of the controlled zone of a blade which presents a defect with the theoretical profile of said zone of the blade such as designed;

FIG. 14b illustrates superposition of the measured curve of evolution of the radius of curvature of the zone corresponding to the measured profile of FIG. 14a, with a theoretical curve of evolution of the radius of curvature of the theoretical profile of FIG. 14a, the conformity parameter measured being shown;

FIG. 15a illustrates superposition of the measured profile of the controlled zone of a blade which presents a defect with the theoretical profile of said zone of the blade such as designed;

FIG. 15b illustrates superposition of the measured curve of evolution of the radius of curvature of the zone corresponding to the measured profile of FIG. 15a, with a theoretical curve of evolution of the radius of curvature of the theoretical profile of FIG. 15a, the measured parameters of conformity being shown;

FIG. 16a illustrates superposition of the measured profile of the controlled zone of a blade which presents a defect with the theoretical profile of said zone of the blade such as designed;

FIG. 16b illustrates superposition of the measured curve of evolution of the radius of curvature of the zone corresponding to the measured profile of FIG. 16a, with a theoretical curve of evolution of the radius of curvature of the theoretical profile of FIG. 16a, the measured conformity parameters being shown;

FIG. 17 illustrates a possible method for detection of inversion of the radius of curvature of the zone of the controlled section of the blade;

FIG. 18 illustrates a blade and the different lines of the sections on which the control method of the conformity of the profile of the leading edge and/or of the trailing edge in the region of said sections can be executed to control the conformity of the profile of the leading edge and/or of the trailing edge of said blade.

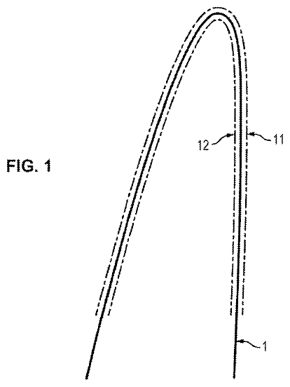

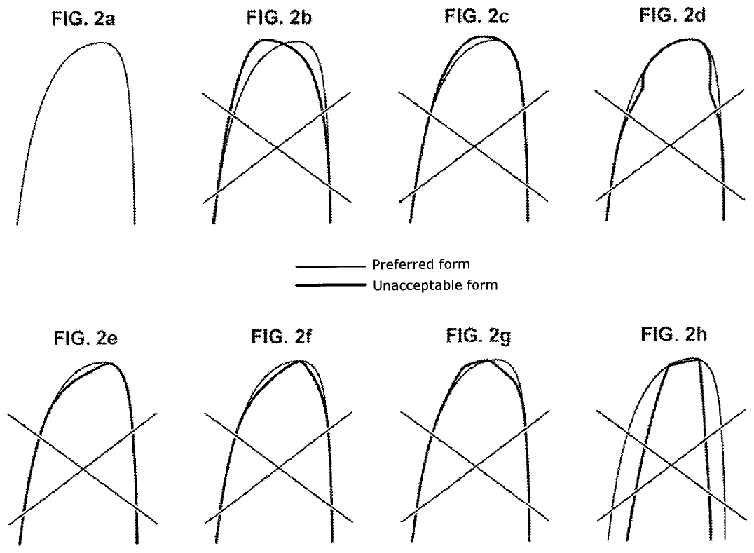

### DESCRIPTION OF ONE OR MORE EXEMPLARY EMBODIMENTS

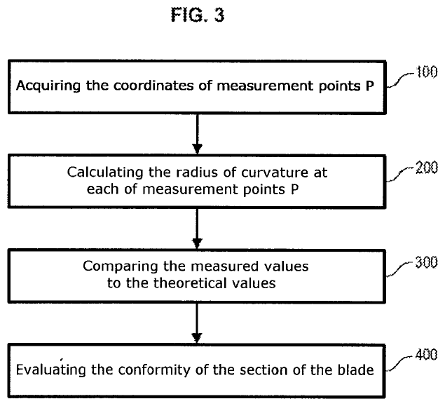

FIG. 3 illustrates a control method of the conformity of a profile of a section of the leading edge and/or of the trailing edge of a blade 2 of a turbomachine.

The control method comprises the following steps:
step 100: acquiring coordinates of several measurement points of the section of a leading edge and/or of a trailing edge of the blade 2 in a frame of reference defined for said section;
step 200: calculating from the coordinates of these measurement points P the radius of curvature of the blade 2 at each of these points, so as to obtain a measured curve of evolution Cm of the radius of curvature according to the position of the measurement points P along the section of the leading edge and/or of the trailing edge;
step 300: comparing the measured curve of evolution Cm of the radius of curvature obtained at the calculation step 200 with a theoretical curve of evolution Ct of the radius of curvature of the section of the predetermined blade 2;
step 400: evaluating the conformity of the section of the blade 2 from the comparison made at the comparison step 300.

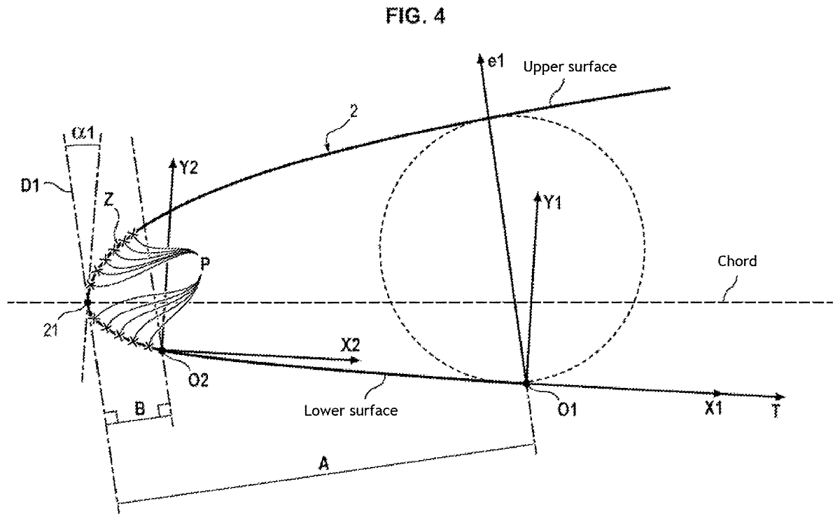

FIG. 4 illustrates an example of a possible acquisition method of the coordinates of measurement points which can be used for conducting step 100 of the control method.

FIG. 4 illustrates a section of a blade 2 normal to the stacking axis of said blade 2.

The section of the blade 2 is defined especially by:
a leading edge point 21;
a trailing edge point (not shown in FIG. 4);
an angle α1 which defines, relative to the perpendicular to the chord, the direction of a tangent D1 to the leading edge point 21;
a value e1 of the thickness of the blade 2 at a predetermined theoretical distance from the tangent D1 to the leading edge point 21, this distance being for example of the order of 3 to 5 mm.

The chord is a straight characteristic of the blade 2 which is defined as the straight line which connects the leading edge point 21 to the trailing edge point.

A frame of reference is defined locally for the section of the blade 2 so that the coordinates of the measurement points P can be measured in this frame of reference specific to this section of the blade 2.

In the example illustrated in FIG. 4, this local frame of reference is a first Cartesian coordinate system defined as follows:
a first point of origin of the axes O1 is on the lower surface side of the blade 2, at a distance A from the straight line D1 given for the thickness e1 in the technical definition of the blade 2 (A being equal to 3 mm in the example illustrated in FIG. 4);
a first axis of abscissa X1 corresponds to the axis passing through the first point of origin of the axes O1 and which is tangential to the blade 2 in the region of this first point of origin of the axes O1;
a first axis of ordinate Y1 is the axis passing through the first point of origin of the axes O1 and which is perpendicular to the first axis of abscissa X1.

Thereafter, so as to control only the zone of the lower surface and of the upper surface of the blade 2 which is near the leading edge point 21, a change of coordinate system is made to recentre the measuring of the coordinates of measurement points P on the leading edge point 21.

To make this change of coordinate system, a second Cartesian coordinate system is defined, the second Cartesian coordinate system comprising:
a second point of origin of the axes O2 is defined on the lower surface surface of the blade 2, at a distance B from the straight line D1 less than the distance e1 (B being equal to 0.5 mm in the example of FIG. 4). The distance B between the second point of origin of the axes O2 and the straight line D1 is adapted as a function of the profile of the blade 2 and is selected so as to cover the portions of the lower surface and of the upper surface of said blade 2 on which the variation in curvature of the blade is the greater.
a second axis of abscissa X2 which corresponds to the axis passing through the second point of origin of the axes O2 and which is parallel to the first axis of abscissa X1;
a second axis of ordinate Y2 which is the axis passing through the second point of origin of the axes O2 and which is parallel to the first axis of ordinate Y1.

The portion of the section of the blade 2 which is controlled by the control method is the zone Z of the section of the blade 2 which is therefore located at most as far as the distance B of the leading edge 21 (the distance B being equal to 0.5 mm in the example of FIG. 4).

Sampling is then made on the zone Z of the section of the blade 2 to obtain the different measurement points P: these are for example selected as being the points of intersection with the lower surface curve and the upper surface curve of different parallels to the straight line D1, spaced relative to each other by a given sampling pitch (0.05 mm for example).

The coordinates of these different measurement points P can be obtained in different ways: mechanical probing, optical measuring, etc.

The example given in FIG. 4 is used in the region of the leading edge 21 of said blade 2. But the example illustrated in FIG. 4 can easily be transposed so it can be utilised for acquiring coordinates of measurement points on a trailing edge of the blade 2.

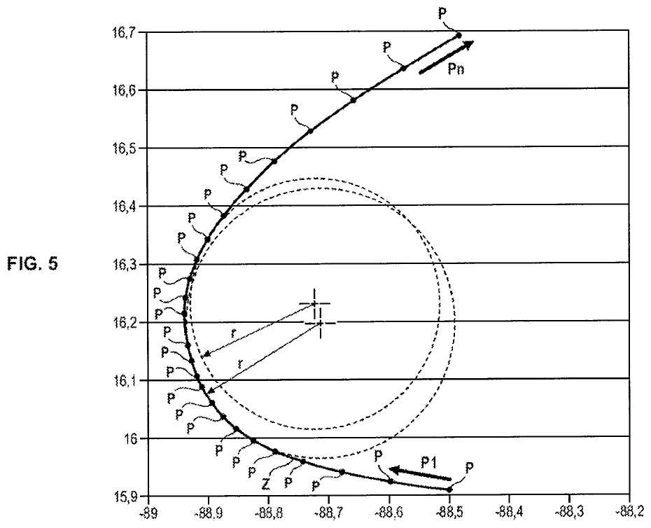

FIG. 5 illustrates an example of a possible method for calculation of the radius of curvature of the controlled zone Z at each of the measurement points P for conducting the step 200 of the control method.

In this way as illustrated in FIG. 5, the measurement points P are distributed along the zone Z of the point P1 (lower surface end) to the point Pn (upper surface end).

For each triplet of measurement points (Pi, Pi+1, Pi+2), for i going from 1 to n−2, the circle Ci passing through the three measurement points Pi, Pi+1, and Pi+2 is determined.

The radius of curvature au point Pi is calculated by measuring the radius Ri of the circle Ci passing through the three points Pi, Pi+1, and Pi+2.

In this way the radius of curvature of the blade 2 at each of the measurement points P is calculated by shifting the circle Ci along the zone Z.

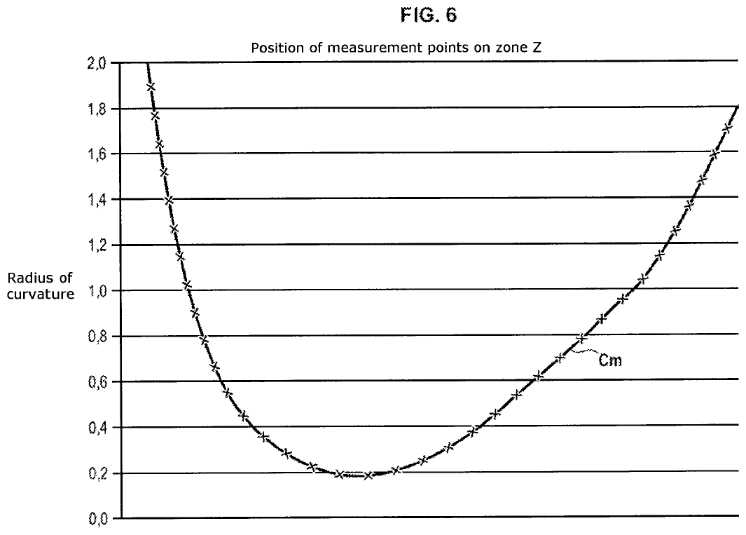

Calculation of the radius of curvature of the blade 2 at each of the measurement points P produces a measured curve of evolution Cm of the radius of curvature of the blade 2 on the zone Z, as shown in FIG. 6.

The measured curve of evolution Cm has as ordinate the radius of curvature at each of the measurement points P, and in abscissa the position of the measurement points P along the zone Z following a curvilinear abscissa.

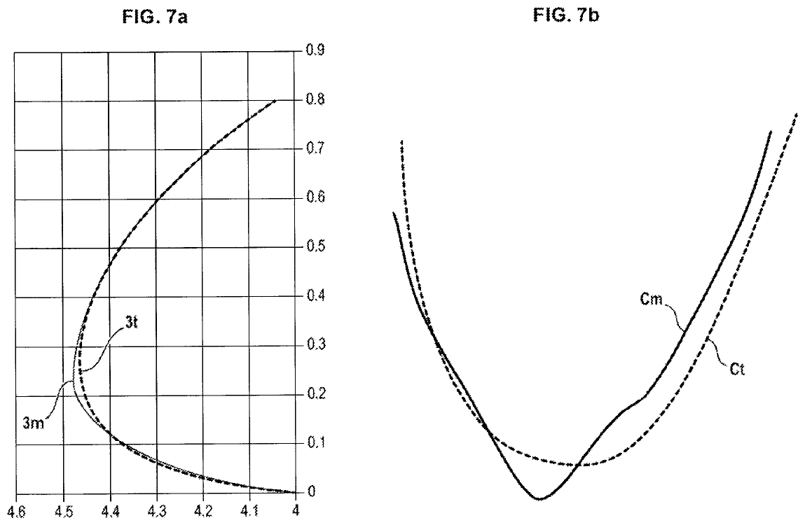

As illustrated in FIGS. 7a, 7b, 8a, 8b and 9a, 9b, the different types of defects which the zone Z can have are seen in different ways on the measured curve of evolution Cm.

FIG. 7a illustrates superposition of the measured profile 3m of the zone Z of a blade 2 which presents a defect with a theoretical profile 3t of the zone Z of the blade 2 such as designed. As seen in FIG. 7a, the blade 2 is too pointed in the region of the leading edge point 21.

FIG. 7b illustrates superposition of the measured curve of evolution Cm of the zone Z corresponding to the measured profile 3m of FIG. 7a, with a theoretical curve of evolution Ct of the radius of curvature of the theoretical profile 3t of FIG. 7a. As seen in FIG. 7b, the measured curve of evolution Cm has a U form in this case.

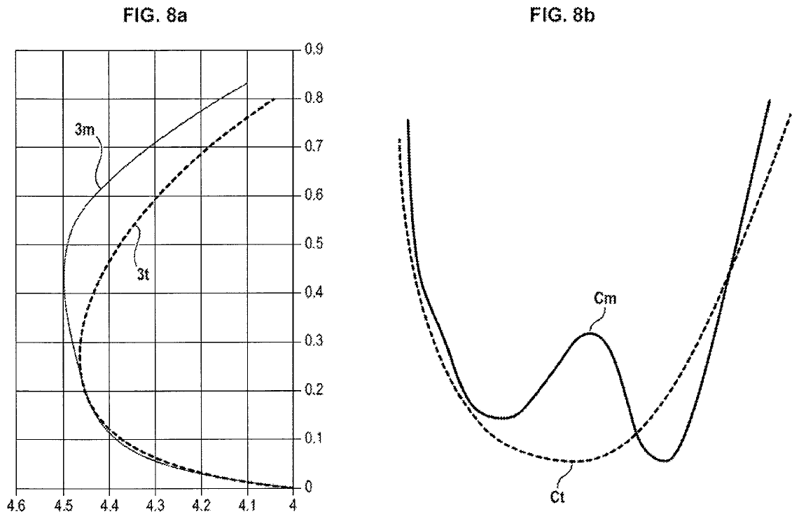

FIG. 8a illustrates superposition of the measured profile 3m of the zone Z of a blade 2 which presents a defect with the theoretical profile 3t of the zone Z of the blade 2 such as designed. As seen in FIG. 8a, the blade 2 has a leading edge point 21 offset relative to the theoretical leading edge point.

FIG. 8b illustrates superposition of the measured curve of evolution Cm of the zone Z corresponding to the measured profile 3m of FIG. 8a, with a theoretical curve of evolution Ct of the radius of curvature of the theoretical profile 3t of FIG. 8a. As seen in FIG. 8b, the measured curve of evolution Cm has a W form in this case.

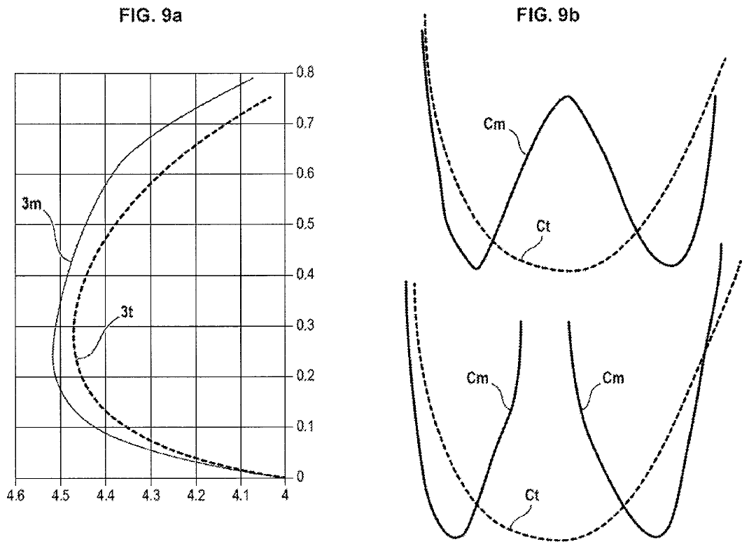

FIG. 9a illustrates superposition of the measured profile 3m of the zone Z of a blade 2 which presents a defect with the theoretical profile 3t of the zone Z of the blade 2 such as designed. As seen in FIG. 9a, the zone Z of the blade 2 has a portion flattened relative to the theoretical profile 3t.

FIG. 9b illustrates superposition of the measured curve of evolution Cm of the zone Z corresponding to the measured profile 3m of FIG. 9a, with a theoretical curve of evolution Ct of the radius of curvature of the theoretical profile 3t of FIG. 9a. As evident in FIG. 9b, the measured curve of evolution Cm has either a W form or a double-U form when the zone Z is too flat. According to a possible variant, the threshold value of radius of curvature is 2 mm so that it is considered that the measured profile 3m comprises a flat spot, and therefore said measured profile is in a double-U form.

As seen in FIGS. 7a, 7b, 8a, 8b and 9a, 9b, the theoretical curve of evolution Ct of the radius of curvature of the zone Z always has a U profile.

The control method proposes determining the type of defect which the zone Z of the blade 2 to be measured has so that the relevant parameters for evaluating the conformity of the blade 2 can be measured according to the defect in the profile of the zone Z. In fact, if the defect is minor, the blade 2 can still be compliant since said blade 2 has the aerodynamic characteristics needed for proper operation of the turbomachine.

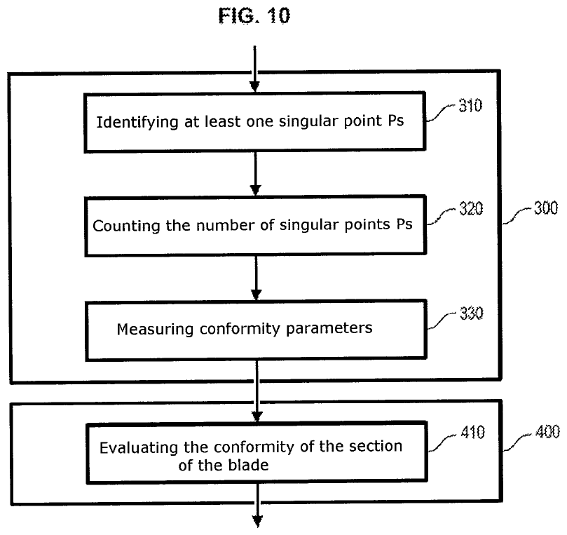

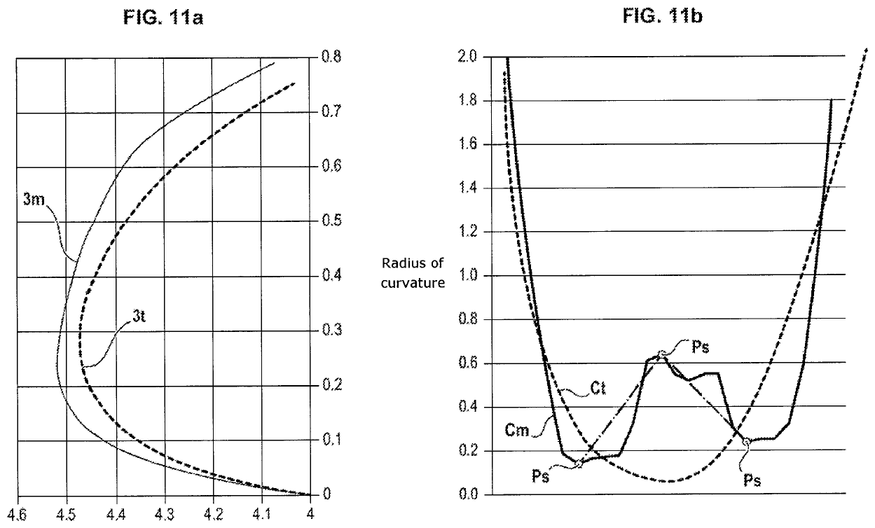

To this end and to distinguish the different profiles of measured curve of evolution Cm of the radius of curvature (U, W, or double U), the comparison step 300 has the following step, as illustrated in FIGS. 10, 11a and 11b:
step 310: identifying at least one singular point Ps in the measured curve of evolution Cm of the radius of curvature. A singular point Ps is a measurement point P which corresponds to a local extremum of the measured curve of evolution Cm.

The local extrema among the measurement points P can for example be identified by detection of the measurement points P whereof the derivative of the measured curve of evolution Cm at these points is zero.

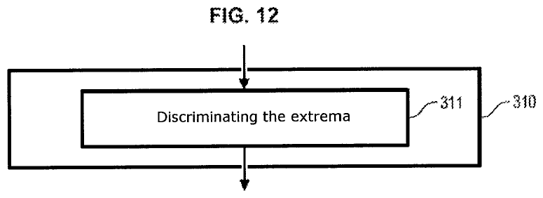

Also, the identification step 310 of the singular points Ps can comprise the following step, as illustrated in FIG. 12:
step 311: discriminating the identified local extrema by retaining as singular point Ps only one extremum whereof the variation in value of the radius of curvature relative to the adjacent extrema is greater than a predetermined threshold.

Such a discrimination step of the extrema does not retain the undulations which the profile of the zone Z of the section of the blade 2 can have as singular point, and retains only as singular point(s) Ps the measurement point(s) P representing veritable maximum and/or minimum in light of the general form of the measured curve of evolution Cm.

The comparison step 300 also has the following step, as illustrated in FIG. 10:
step 320: counting the number of singular points identified at the step 310.

Such a step determines the type of defect which the profile of the zone Z of the blade Z has, among possible different defects.

In this way for a U-shaped profile, the measured curve of evolution Cm of the radius of curvature of the zone Z comprises a single minimum forming a single singular point Ps.

For a W-shaped profile, the measured curve of evolution Cm comprises only two minimums and a maximum, therefore forming only three singular points Ps. Two of the singular points Ps each correspond to the minimum, and the remaining singular point Ps which is located between the two other singular points Ps corresponds to the maximum.

For a profile shaped as a double U, the measured curve of evolution Cm comprises only two minimums, therefore forming two single singular points Ps, each singular point PS corresponding to a minimum.

The fact of knowing the number of singular points, and therefore the type of defect presented by the profile of the zone Z of the blade 2, determines which parameters are relevant for measuring by comparing the measured curve of evolution Cm to the theoretical curve of evolution Ct to estimate the importance of the defect.

In this way as illustrated in FIG. 10, the comparison step 300 has also the following step:
step 330: measuring parameters of conformity by comparing the singular points Ps of the curve of evolution Cm to particular points Pp of the theoretical curve of evolution Ct of the radius of curvature of the profile of the zone Z, the measured parameters and the particular points Pp of the theoretical curve of evolutions Ct depending on the number of singular points Ps counted at the counting step 320.

As illustrated in FIG. 10, the evaluation step 400 of the conformity of the section of the blade 2 comprises the following step:
step 410: evaluating the conformity of the section of the blade 2 by comparing the measured parameters at the step 330 to predetermined values.

This evaluation step 410 of the conformity of the section of the blade concludes whether the leading edge and/or the trailing edge of the section of the controlled blade 2 presents an appropriate profile relative to the theoretical profile set when the blade 2 was designed.

The predetermined values depend on the parameters measured during the measuring step 330, as well as of the tolerance given to the profile of the blade 2.

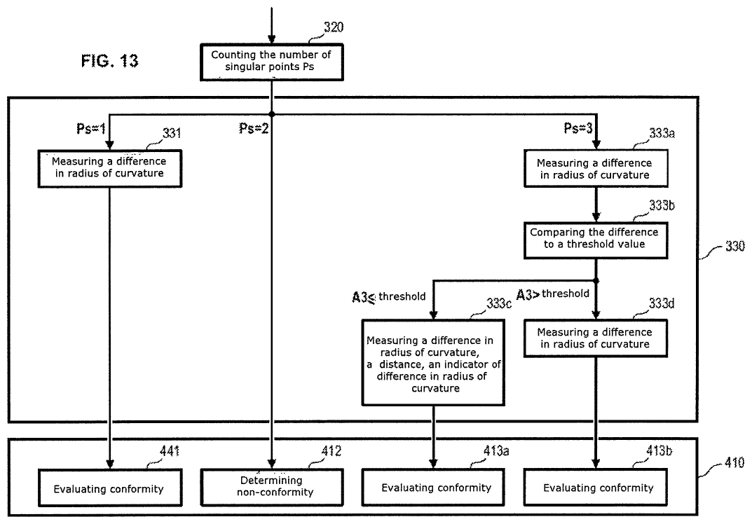

As illustrated in FIGS. 13, 14a, 14b, 15a, 15b, and 16a, 16b, the step 330 for measuring the parameters of conformity can comprise the following steps:
step 331: measuring, when a single singular point Ps is counted, the difference in radius of curvature S1 on the one hand between the singular point Ps and on the other hand a particular point Pp corresponding to the minimum of the radius of curvature of the theoretical curve of evolution Ct of the radius of curvature of the zone Z;
step 333a: measuring, when only three singular points Ps are counted, the difference in radius of curvature A3 on the one hand between a singular point Ps among said three singular points Ps having the maximum radius of curvature, and on the other hand a particular point Pp corresponding to the point of the theoretical curve of evolution Ct having the same position along the section as the singular point Ps having the maximum radius of curvature;
step 333b: comparing this difference in radius of curvature A3 to a predetermined threshold value;
step 333c: measuring, if the difference in radius of curvature A3 is less than or equal to the threshold value, the following parameters:
   the distance L2 along the section on the one hand between a singular point Ps among the three singular points Ps having the minimum radius of curvature, and on the other hand a particular point Pp having the minimum radius of curvature of the theoretical curve of evolution Ct;
   the sign of the difference in radius of curvature Dr on the one hand between the singular point Ps having the minimum radius of curvature, and on the other hand the particular point Pp having the minimum radius of curvature;
   the difference in radius of curvature A2 on the one hand between the singular point Ps having the minimum radius of curvature, and on the other hand a particular point Pp corresponding to the point of the theoretical curve of evolution having the same position along the section as the singular point Ps having the minimum radius of curvature;
step 333d: measuring, if the difference in radius of curvature A3 is greater than the threshold value, the distance L3 along the section between the two singular points Ps other than the singular point Ps having the maximum radius of curvature.

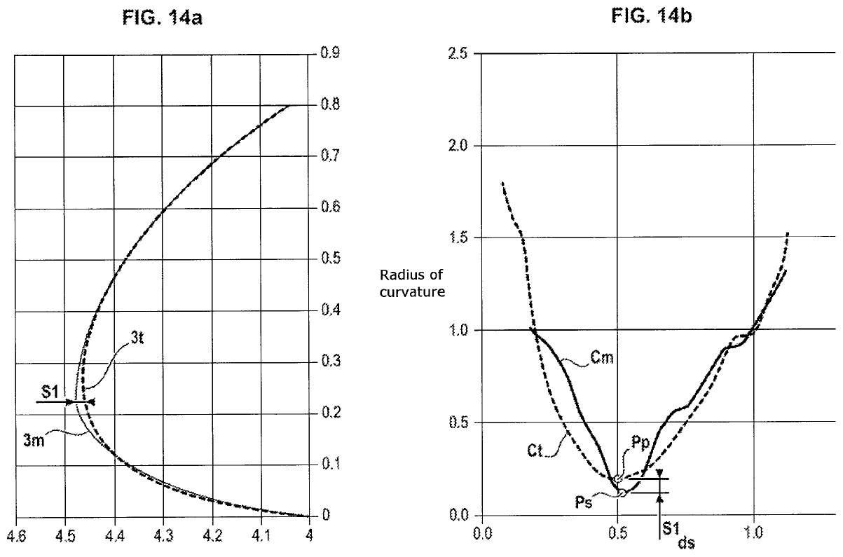

FIGS. 14a and 14b illustrate the way in which the measuring step 331 of the difference in radius of curvature S1 can be conducted by comparing the measured curve of evolution Cm and the theoretical curve of evolution Ct.

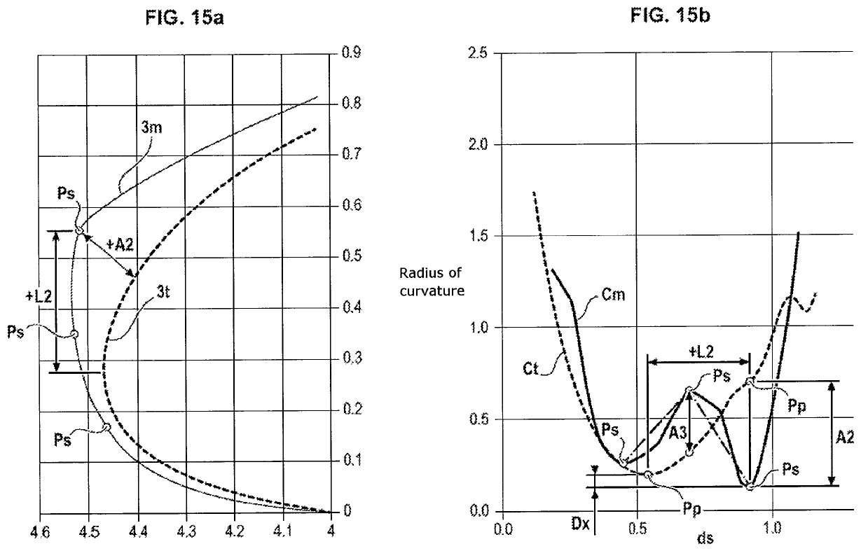

FIGS. 15a and 15b illustrate the way in which the measuring steps 333a and 333c of the difference in radius of curvature A3, of the distance L2, of the sign of the difference in radius of curvature Dr, and of the difference in radius of curvature A2 can be conducted.

The difference in radius of curvature Dr is positive if the radius of curvature of the singular point Ps having the minimum radius of curvature is greater than the radius of curvature of the particular point Pp having the minimum radius of curvature of the theoretical curve of evolution Ct.

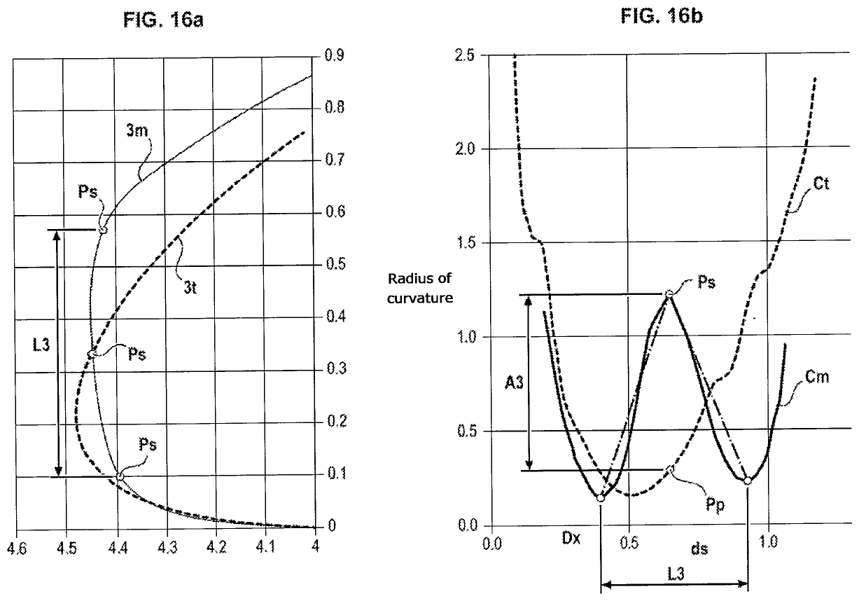

FIGS. 16a and 16b illustrate the way in which the measuring steps 333a and 333d of the difference in radius of curvature A3, and of the distance L3 can be conducted.

The evaluation step 410 of the conformity of the section of the leading edge and/or of the trailing edge of the blade 2 comprises the following steps:
step 411: evaluating the conformity of the section the blade 2, when a single singular point Ps is counted, by comparing the difference in radius of curvature S1 measured at the step 331 at a predetermined tolerance threshold. The tolerance threshold for the difference in radius of curvature S1 is for example 0.1 mm.
step 413a: evaluating the conformity of the section the blade 2, when only three singular points are counted and that the difference in radius of curvature A3 is less than or equal to the threshold value, by comparing the distance L2, the difference in radius of curvature A2, and the sign of the difference in radius of curvature Dr measured at the step 333c to predetermined tolerance thresholds. The tolerance threshold for the difference in radius of curvature A2 is for example 0.3 mm. The tolerance threshold for the length L2 is for example 0.5 mm. The tolerance threshold for the sign of the difference in radius of curvature Dr is that the difference in radius of curvature Dr is negative (case illustrated in FIGS. 15a and 15b.
step 413b: evaluating the conformity of the section the blade 2, when only three singular points are counted and that the difference in radius of curvature A3 is greater than the threshold value, by comparing the distance L3 and the difference in radius of curvature A3 measured at step 333d to predetermined tolerance thresholds. The tolerance threshold for the difference in radius of curvature A3 is for example 2 mm. The tolerance threshold for the length L3 is for example 0.15 mm.

The values of the tolerance thresholds can be varied as per the dimensions of the blades to be controlled.

Also, as evident in FIG. 13, when only two singular points Ps are counted during the counting step 310 of the singular points Ps of the measured curve of evolution Cm, the profile of the zone Z of the section of the blade 2 is directly considered as non-compliant said zone Z in a step 412 for determination of non-conformity.

In fact, the section Z has an excessively large flat spot if only 2 singular points Ps are counted.

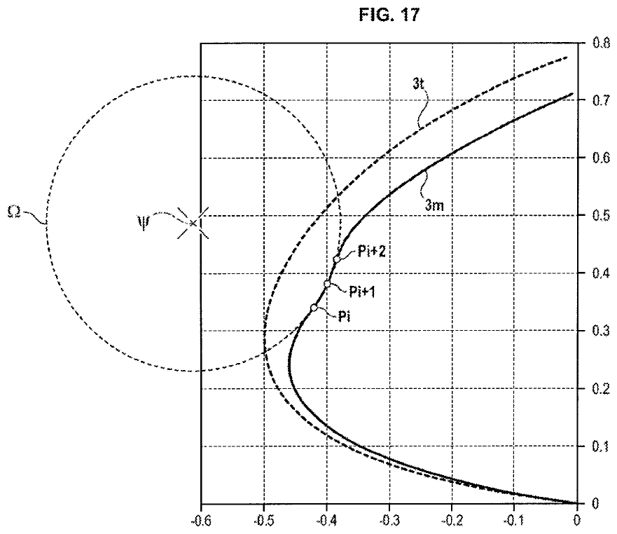

According to a preferred variant illustrated in FIG. 17, the control method of the conformity of the profile of the section of the leading edge and/or of the trailing edge of the blade 2 comprises the following steps for detecting inversion of curvature in said section:
step 510: detecting inversion of curvature by determining a centre ψ of a circle Ω passing through three measurement points P and if said centre ψ of the circle Ω is located outside the section of the blade 2;
step 520: setting the section of the blade 2 as non-compliant if the centre ψ of the circle Ω is located outside the section of said blade 2.

Therefore, in the example illustrated in FIG. 17 the profile of the section of the leading edge of the blade 2 comprises inversion of curvature, the centre ψ of the circle Ω being located outside the section of the blade 2.

To verify the absence of inversion of curvature on the zone Z of the section of the blade 2, the circle Ω and its centre ψ are shifted along said zone Z by a triplet of measurement points (Pi, Pi+1, Pi+2) by incrementing i.

According to a possible execution of the method of the conformity of the profile of the section of the blade 2, said section is considered as non-compliant if one of the parameters of conformity measured in step 330 is not compliant with its tolerance threshold, for example by being greater than the maximum value, less than the minimum value, if the length is too great, or if the sign of the difference in radius of curvature is different to the predetermined sign.

The invention also proposes a control method of the conformity of the profile of the leading edge and/or of the trailing edge of the blade 2 all along said blade 2, or over a portion only.

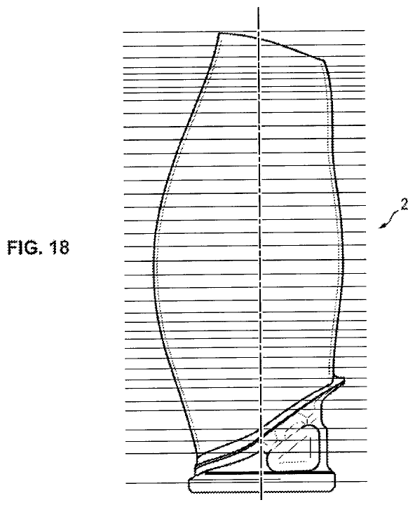

To this end, as illustrated in FIG. 18, the control method of the conformity of a section of the blade 2 such as described previously is executed on different sections Sc distributed along the height of said blade 2.

According to a possible execution of the method of the conformity of the profile of the leading edge and/or of the trailing edge of the blade 2, said profile is considered as non-compliant if the control method of the conformity of the profile of a section of the blade 2 has concluded the non-conformity of a section of said blade 2. The profile of the leading edge and/or of the trailing edge of the blade 2 is considered as compliant if no profile of a section of the blade 2 has been considered as non-compliant.

The exemplary embodiments given previously of the control method of the conformity of the profile of a section of a curved surface of an element of a turbomachine are relative to the cases where the element is a turbomachine blade and the curved surface is the leading edge and/or the trailing edge of said blade. However, the control method of the conformity of the profile of the section of the curved surface of the element of the turbomachine can be applied to elements other than a blade or a rectifier (fixed blade) whereof the form adapted to be aerodynamic impacts the performances of the turbomachine.

1. A control method of the conformity of a profile of a section of a curved surface of an element of a turbomachine comprising the following steps:
acquiring coordinates of several measurement points of the section in a frame of reference defined for said section;
wherein the method comprises the following steps:
calculating from the coordinates of these measurement points the radius of curvature of the section at each of these points so as to obtain a measured curve of evolution of the radius of curvature according to the position of the measurement points along said section;
comparing the measured curve of evolution of the radius of curvature obtained at the preceding step to a theoretical curve of evolution of the radius of curvature of the section which is predetermined, with the following steps
identifying at least one singular point in the measured curve of evolution of the radius of curvature corresponding to a local extremum of said measured curve of evolution;
counting the number of identified singular points;
measuring parameters of conformity by comparing the singular points to particular points of the theoretical curve of evolution of the radius of curvature, the measured parameters and the particular points of the theoretical curve of evolution depending on the number of singular points counted at the preceding step;
evaluating the conformity of the section of the curved surface from the comparison performed at the preceding step by evaluation of the conformity of the section of the curved surface by comparing the parameters to predetermined values.

2. The method according to claim 1, wherein the calculation of the radius of curvature at a measurement point is performed by measuring the radius of a circle passing through said measurement point and the two measurement points which follow said measurement point along the section.

3. The method according to claim 1, wherein the identification step of at least one singular point comprises the following step:
discriminating the identified local extrema by retaining as singular point only one extremum whereof the variation in value of the radius of curvature relative to the adjacent extrema is greater than a predetermined threshold.

4. The method according to claim 1, wherein said method comprises the following steps:
measuring, when a single singular point is counted, a difference in radius of curvature on the one hand between the singular point and on the other hand a particular point corresponding to the minimum of the radius of curvature of the theoretical curve of evolution of the radius of curvature;
evaluating the conformity of the section of the curved surface by comparing the difference in radius of curvature measured at the preceding step to a predetermined tolerance threshold.

5. The method according to claim 1, wherein said method comprises the following step:
setting, when only two singular points are counted, the section of the curved surface as non-compliant.

6. The method according to claim 1, wherein said method comprises the following steps:
measuring, when only three singular points are counted, a difference in radius of curvature on the one hand between a singular point among said three singular points having the maximum radius of curvature, and on the other hand a particular point corresponding to the point of the theoretical curve of evolution having the same position along the section as the singular point having the maximum radius of curvature;
comparing this difference in radius of curvature to a predetermined threshold value;
measuring, if the difference in radius of curvature is less than the threshold value, the following parameters:
a distance along the section on the one hand between a singular point among the three singular points having the minimum radius of curvature, and on the other hand a particular point having the minimum radius of curvature of the theoretical curve of evolution;
an sign of a difference in radius of curvature on the one hand between the singular point having the minimum radius of curvature, and on the other hand the particular point having the minimum radius of curvature;
a difference in radius of curvature on the one hand between the singular point having the minimum radius of curvature, and on the other hand a particular point corresponding to the point of the theoretical curve of evolution having the same position along the section as the singular point having the minimum radius of curvature;
evaluating the conformity of the section of the curved surface by comparing the distance, the difference in radius of curvature, and the sign of the difference in radius of curvature measured at the preceding step to predetermined tolerance thresholds.
measuring, if the difference in radius of curvature is greater than the threshold value, a distance along the section between the two singular points other than the singular point having the maximum radius of curvature;
evaluating the conformity of the section of the curved surface by comparing the distance measured at the preceding step, as well as the difference in radius of curvature on the one hand between the singular point having the maximum radius of curvature and on the other hand the particular point of the theoretical curve of evolution having the same position along the surface, to predetermined tolerance thresholds.

7. The method according to claim 1, wherein said method comprises the following steps:
detecting inversion of curvature by determining a centre of a circle passing through three measurement points and whether said centre of the circle is located outside the section of the curved surface;
setting the section of the curved surface as non-compliant if the centre of the circle is located outside the section of said curved surface.

8. The control method of the conformity of a profile of a leading edge and/or of a trailing edge of a blade of a turbomachine comprising the following step:
executing the control method of the conformity of the profile of a section of a curved surface of an element according to claim 1, wherein the element is the blade and said curved surface comprises the leading edge and/or the trailing edge of said blade, said control method being executed on a plurality of sections of said blade distributed along said blade.
